(19) United States
(12) Patent Application Publication
(10) Pub. No.: US 2025/0030760 A1
(43) Pub. Date: Jan. 23, 2025

(54) CONCURRENT DATA TRANSMISSION

(71) Applicant: Dell Products L.P., Round Rock, TX (US)

(72) Inventors: Helen Dong, Chengdu (CN); Renyuan Tong, Chengdu (CN); Xuhui Yang, Chengdu (CN); Yang Zhao, Chengdu (CN)

(21) Appl. No.: 18/477,273

(22) Filed: Sep. 28, 2023

(30) Foreign Application Priority Data
Jul. 21, 2023 (CN) 202310907985.5

(51) Int. Cl. H04L 67/1095; G06F 16/27; H04L 43/0882

(52) U.S. Cl. CPC H04L 67/1095; G06F 9/4881; G06F 9/5044; G06F 16/27; H04L 43/0882; G06F 2209/5017; G06F 2209/5019

(57) ABSTRACT

For concurrent data transmission, an example method includes acquiring a processor utilization rate related to transmission of historical data packet(s) and a bandwidth utilization rate of a data link within a target time period. A time consumption for transmitting a target data packet, a splitting processing resource related to a splitting operation, and a packaging processing resource related to a packaging operation are determined. Based on the processor utilization rate, the bandwidth utilization rate, the time consumption, the splitting processing resource, and the packaging processing resource, a split number is determined for the target data packet to concurrently transmit the target data packet. In this way, a data transmission speed can be improved, time consumed for transmitting the target data packet can be reduced, and meanwhile, it can also alleviate problems such as excessive processing resource consumption and overloaded operation of the processor caused by concurrent transmission.

### RELATED APPLICATION

The present application claims the benefit of priority to Chinese Patent Application No. 202310907985.5, filed on Jul. 21, 2023, which application is hereby incorporated into the present application by reference herein in its entirety.

### TECHNICAL FIELD

The present disclosure relates to the field of data storage, and more specifically, relates to concurrent data transmission.

### BACKGROUND

A Recovery Point Objective (RPO) refers to a degree of data loss that an organization or system can tolerate in the event of a failure. The RPO is usually measured in time units, representing the time of the last valid data backup before a failure occurred. A lower RPO indicates that data is replicated and backed up at a higher frequency, and in the event of a failure, the organization or system will suffer data loss in a shorter period of time. A higher RPO indicates that the organization or system can tolerate data loss for a longer period of time.

Replication snapshot is a method of data backup and recovery in a computer system. Replication snapshot is to take a snapshot of data at a certain time point, and then replicate the snapshot to another location or storage system to provide data redundancy and fault recovery capability.

### SUMMARY

Embodiments of the present disclosure propose a method, a device, and a computer program product for concurrent data transmission. In the embodiments of the present disclosure, statistical data such as processor utilization rate related to transmission of a historical data packet and bandwidth utilization rate of a data link within a past target time period can be acquired. Moreover, time consumption for transmitting a target data packet can be calculated, and a processing resource to be consumed for splitting a data packet in a source storage system and a processing resource to be consumed for packaging multiple data packets in a destination storage system can be determined. Then, an optimal split number can be calculated based on these data. Thus, when the target data packet is transmitted, the source storage system can split the target data packet into multiple data packets based on the calculated split number and concurrently transmit them to the destination storage system, and then the multiple data packets are packaged into the target data packet at the destination storage system. In this way, a target data packet can be concurrently transmitted, thereby improving a data transmission speed and reducing time consumed in transmitting the target data packet. At the same time, it can also alleviate the problems of excessive processing resource consumption and overloaded operation of the processor caused by concurrent transmission, so as to ensure an acceptable processor performance for the source storage system and the destination storage system while improving the data transmission speed.

In a first aspect of the embodiments of the present disclosure, a method for concurrent data transmission is provided. The method includes acquiring a processor utilization rate related to transmission of one or more historical data packets and a bandwidth utilization rate of a data link within a target time period. The method further includes determining time consumption for transmitting a target data packet, a splitting processing resource related to a splitting operation, and a packaging processing resource related to a packaging operation. The method further includes determining, based on the processor utilization rate, the bandwidth utilization rate, the time consumption, the splitting processing resource, and the packaging processing resource, a split number for the target data packet to concurrently transmit the target data packet.

In a second aspect of the embodiments of the present disclosure, an electronic device is provided. The electronic device includes one or more processors; and a storage apparatus used to store one or more programs, and when the one or more programs are executed by the one or more processors, enable the one or more processors to implement a method for concurrent data transmission. The method includes acquiring a processor utilization rate related to transmission of one or more historical data packets and a bandwidth utilization rate of a data link within a target time period. The method further includes determining time consumption for transmitting a target data packet, a splitting processing resource related to a splitting operation, and a packaging processing resource related to a packaging operation. The method further includes determining, based on the processor utilization rate, the bandwidth utilization rate, the time consumption, the splitting processing resource, and the packaging processing resource, a split number for the target data packet to concurrently transmit the target data packet.

In a third aspect of the embodiments of the present disclosure, a computer readable storage medium is provided, and stores a computer program thereon. The program, when being executed by a processor, implements a method for concurrent data transmission. The method includes acquiring a processor utilization rate related to transmission of one or more historical data packets and a bandwidth utilization rate of a data link within a target time period. The method further includes determining time consumption for transmitting a target data packet, a splitting processing resource related to a splitting operation, and a packaging processing resource related to a packaging operation. The method further includes determining, based on the processor utilization rate, the bandwidth utilization rate, the time consumption, the splitting processing resource, and the packaging processing resource, a split number for the target data packet to concurrently transmit the target data packet.

It should be understood that the content described in the Summary of the Invention part is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 shows a schematic diagram of an example environment in which a plurality of embodiments of the present disclosure can be implemented;

FIG. 2 shows a schematic diagram of a process of replicating incremental data based on RPO asynchronous transmission according to some embodiments of the present disclosure;

FIG. 3 shows a flowchart of a method for concurrent data transmission according to some embodiments of the present disclosure;

FIG. 4A to FIG. 4B show a schematic diagram of a process of splitting a replication snapshot at a source storage system according to some embodiments of the present disclosure, and a schematic diagram of a process of packaging multiple split data packets at a destination storage system according to some embodiments of the present disclosure;

FIG. 5 shows a flowchart of a process of determining whether to concurrently transmit a replication snapshot and determining a split number according to some embodiments of the present disclosure;

FIG. 6 shows a schematic diagram of a process of determining a performance gain score according to some embodiments of the present disclosure;

FIG. 7 shows a schematic diagram of an example of determining a maximum performance gain score according to some embodiments of the present disclosure; and

FIG. 8 shows a block diagram of a device that can implement multiple embodiments of the present disclosure.

### DETAILED DESCRIPTION

The following will describe the embodiments of the present disclosure in more detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the protection scope of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

Data replication is a process of creating copies or backups of data from a source storage system in a destination storage system, and data replication includes synchronous and asynchronous replication. Synchronous replication can create data copies in real time, but creating data copies in real time will have an adverse impact on host writes, and can only be achieved in scenarios with short transmission distances. Asynchronous replication is designed for data replication in scenarios with long transmission distances. Asynchronous replication can perform periodic replication in the background without negatively affecting the performance of a host. However, since the replication process is asynchronous instead of in real time, there may be some degree of data loss. A Recovery Point Objective (RPO) refers to a maximum acceptable amount of data loss in the event of a catastrophic event or data loss, and the RPO is represented by a period of time, such as 30 minutes, 1 hour, 2 hours, etc. If the RPO of a system is 1 hour, it means that an interval between the time of the disaster and the last data replication by the system does not exceed 1 hour.

In order to reduce the amount of data loss, users (such as system administrators) can choose a small RPO value (such as 5 minutes) and hope that in the event of a failure, only a small amount of data will be lost. However, when an I/O task is heavy and the source storage system has a large number of storage objects involving asynchronous replication sessions, such a situation may occur—when approaching the second RPO, transmission of the incremental data to be replicated by the first RPO from the source storage system to the destination storage system is not completed. In this case, if a disaster occurs during the second RPO, data from both RPOs may be lost. Therefore, it is necessary to improve the data transmission performance to ensure that transmission of all incremental data is completed within a time window required by the RPO.

Hence, an embodiment of the present disclosure proposes a solution for concurrently transmitting data. In the embodiment of the present disclosure, statistical data such as a processor utilization rate for transmitting a historical replication snapshot (which is also referred to as a historical data packet) and a bandwidth utilization rate of a data link within a past RPO (which is also referred to as target time period) can be acquired. Moreover, time consumption for transmitting a target data packet can be calculated, and a processing resource to be consumed for splitting a data packet in a source storage system and a processing resource to be consumed for packaging multiple data packets in a destination storage system can be determined. Then, an optimal split number can be calculated based on these data. Thus, when a target replication snapshot (which is also referred to as the target data packet) is transmitted, the source storage system can split the target replication snapshot into multiple data packets based on the calculated split number and concurrently transmit them to the destination storage system, and then the multiple data packets can be packaged into the target replication snapshot at the destination storage system.

In this way, a target replication snapshot can be concurrently transmitted, thereby improving a data transmission speed and improving bandwidth utilization rate of a data link, reducing a case of not completing replication snapshot transmission within RPO time. Meanwhile, it can also alleviate the problems of excessive processing resource consumption and overloaded operation of the processor caused by concurrent transmission, so as to ensure an acceptable processor performance for the source storage system and the destination storage system while improving the data transmission speed.

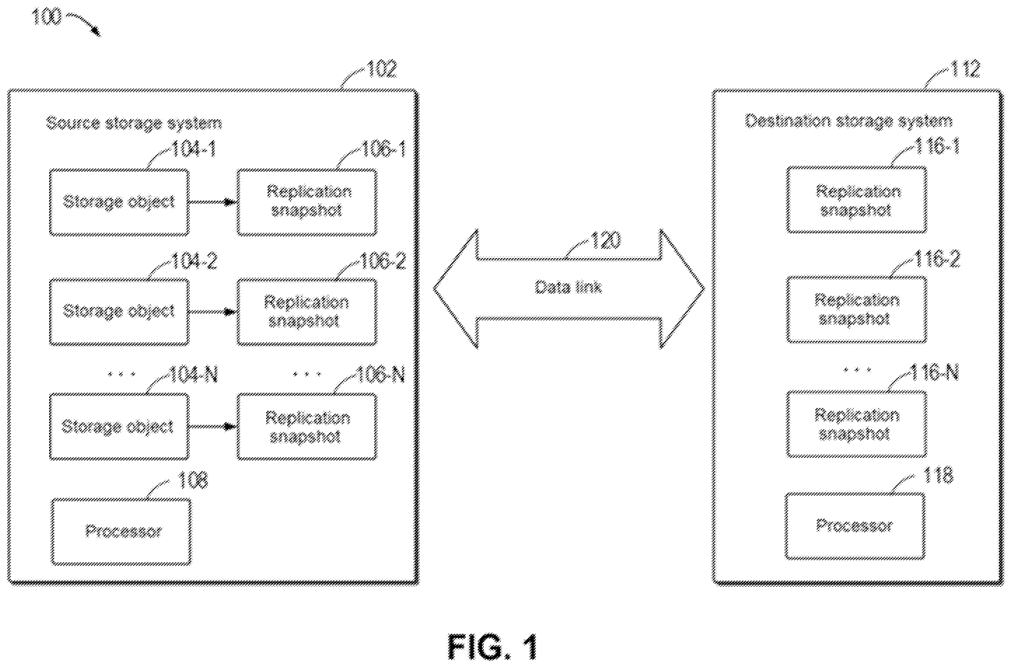

FIG. 1 shows a schematic diagram of an example environment 100 in which multiple embodiments of the present disclosure can be implemented therein. As shown in FIG. 1, the environment 100 includes a source storage system 102 and a destination storage system 112. The source storage system 102 includes storage objects 104-1, 104-2, . . . , and 104-N (which are all referred to as a storage object 104). The storage objects are a way of organizing and managing data in a storage system, which can be data blocks of any size, and can be files, database records, images, videos, and other types of data. In the environment 100, the storage object 104 is replicated or backed up by means of asynchronous replication sessions. As shown in FIG. 1, each storage object 104 has a related replication snapshot, i.e., replication snapshots 106-1, 106-2, . . . , and 106-N (which are all referred to as a replication snapshot 106).

As shown in FIG. 1, in the environment 100, a data link 120 can be used to transmit data between the source storage system 102 and the destination storage system 112. For example, the data link 120 can be used to transmit the replication snapshot 106 from the source storage system 102 to the destination storage system 112, so as to create replication snapshots 116-1, 116-2, . . . , and 116-N (which are all referred to as a replication snapshot 116) at the destination storage system as a transmission result. The data link 120 has a theoretical bandwidth, and the theoretical bandwidth refers to a maximum transmission speed supported by the data link 120, indicates a maximum data amount that can be transmitted by the data link 120 in an ideal condition, and is often measured by the number of bits transmitted per second (bps). For example, if the theoretical bandwidth of the data link 120 is 100 Mbps, it indicates that it can transmit 100 megabits of data per second under ideal conditions. However, in fact, due to other factors (such as signal interference, bandwidth sharing, transmission delay, etc.) that may exist in the network, an actual transmission speed of 100 Mbps may not be achieved.

As shown in FIG. 1, in the environment 100, the source storage system 102 includes a processor 108, and the destination storage system 112 includes a processor 118. The processors 108 and 118 may execute operations related to storage management, such as data access, data compression and decompression, data replication, and some computation tasks. The capabilities and performance of the processors 108 and 118 can directly affect indexes such as the throughput and response time of the source storage system 102 and the destination storage system 112.

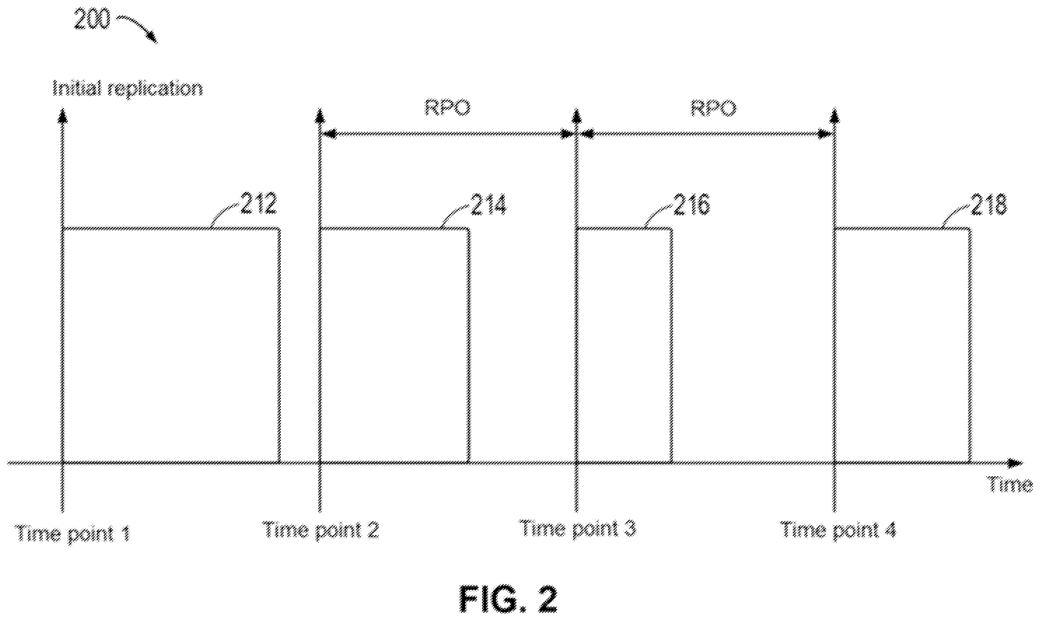

FIG. 2 shows a schematic diagram of a process 200 of replicating incremental data based on RPO asynchronous transmission according to some embodiments of the present disclosure. As shown in FIG. 2, in the process 200, data to be replicated (that is, the replication snapshot 212) in a source storage system (for example, the source storage system 102 in FIG. 1) is replicated to a destination storage system (for example, the destination storage system 112 in FIG. 1) at a time point 1 for the first time, and the first replication is also referred to as initial replication. After the initial replication is completed, incremental data will be replicated according to an RPO-based plan in the process 200. Changes in these incremental data since the last replication will be monitored to achieve a faster replication speed and lower storage requirements. When a system disaster occurs, administrators can choose to restore the system to the time point of the last incremental replication to minimize data loss.

As shown in FIG. 2, in the process 200, replication incremental data will be transmitted at a time point 2 from the source storage system 102 to the destination storage system 112 at an interval of the RPO time. For example, at the time point 2, a replication snapshot 214 is transmitted from the source storage system 102 to the destination storage system 112 in the process 200. After the RPO time, at a time point 3, a replication snapshot 216 is transmitted from the source storage system 102 to the destination storage system 112 in the process 200. After another RPO time, at a time point 4, a replication snapshot 218 is transmitted from the source storage system 102 to the destination storage system 112 in the process 200. It should be noted that the replication snapshots 214, 216, and 218 may include one or more replication snapshots, and the number of the replication snapshots depends on newly added or modified data since the last replication.

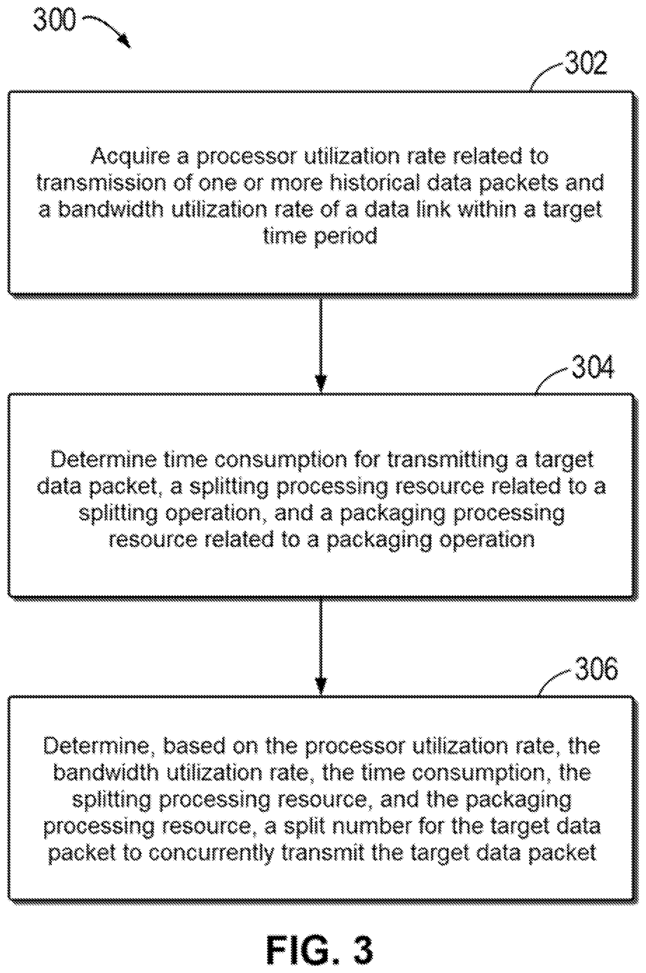

FIG. 3 shows a flowchart of a method 300 for concurrent data transmission according to some embodiments of the present disclosure. As shown in FIG. 3, in a block 302, a method 300 includes acquiring a processor utilization rate related to transmission of one or more historical data packets and a bandwidth utilization rate of a data link within a target time period. For example, in the process 200 shown in FIG. 2, the method 300 may include acquiring a processor utilization rate (for example, a processor utilization rate of the processor 108 of the source memory 102 and a processor utilization rate of the processor 118 of the destination storage system 112 in FIG. 1) related to transmission of the replication snapshot 214 and a bandwidth utilization rate of a data link (for example, the data link 120 in FIG. 1) at the time point 3 within the RPO time between the time point 2 to the time point 3.

At a block 304, the method 300 includes determining time consumption for transmitting a target data packet, a splitting processing resource related to a splitting operation, and a packaging processing resource related to a packaging operation. For example, in the environment 100 shown in FIG. 1, time consumption for transmitting the replication snapshot 106 can be calculated based on a data size of the replication snapshot 106 and an average transmission speed of the data link 120. In addition, the processor 108 of the source storage system 102 may perform the splitting operation to split a data packet into multiple data packets. In this text, an operation of splitting one data packet into two data packets is referred to as one splitting operation. The method 300 may include determining processor consumption required for performing one splitting operation by the processor 108 of the source storage system 102. Besides, the processor 118 of the destination storage system 112 may perform the packaging operation to package multiple data packets into one data packet. In this text, an operation of packaging two data packets into one data packet is referred to as one packaging operation. The method 300 may include determining processor consumption required for performing one packaging operation by the processor 118 of the destination storage system 112.

At a block 306, the method 300 includes determining, based on the processor utilization rate, the time consumption, the bandwidth utilization rate, the splitting processing resource, and the packaging processing resource, a split number for the target data packet to concurrently transmit the target data packet. For example, in the process 200 shown in FIG. 2, the method 300 may include determining the split number for the replication snapshot 216 based on the processor utilization rate, the time consumption, and the bandwidth utilization rate for transmitting the replication snapshot 214 within the RPO time between the time point 2 to the time point 3, a processor resource required for performing one splitting operation by the processor 108 of the source storage system 102, and a processor resource required for performing one packaging operation by the processor 118 of the destination storage system 112. After the split number is determined, the source storage system 102 can split the replication snapshot 216 into a split number of sub data packets before transmitting the replication snapshot 216, and then concurrently transmit these data packets. Then the destination storage system 112 can package the split number of sub data packets into a complete replication snapshot based on identifiers in the sub data packets for storage.

In this way, in the method 300, a replication snapshot 216 can be concurrently transmitted so as to improve a data transmission speed and improve a bandwidth utilization rate of the data link 120, and reduce the possibility of failing to complete the transmission of the replication snapshot 216 within the RPO time between the time point 3 and the time point 4 shown in FIG. 2. Meanwhile, it can also alleviate the problems of excessive resource consumption of processors 108 and 118 of the source storage system 102 and the destination storage system 112 and overloaded operation of the processors caused by concurrent transmission, so as to ensure acceptable performance of the processors 108 and 118 for the source storage system 102 and the destination storage system 112 while improving the data transmission speed.

In some embodiments, to speed up the transmission speed, a to-be-transmitted target data packet can be split into multiple sub data packets at the source storage system, and the data link is used to concurrently transmit the multiple sub data packets to the destination storage system. After receiving the multiple sub data packets, the destination storage system can package the multiple sub data packets to obtain the recovered target data packet, so as to complete the process of replicating the target data packet from the source storage system to the destination storage system.

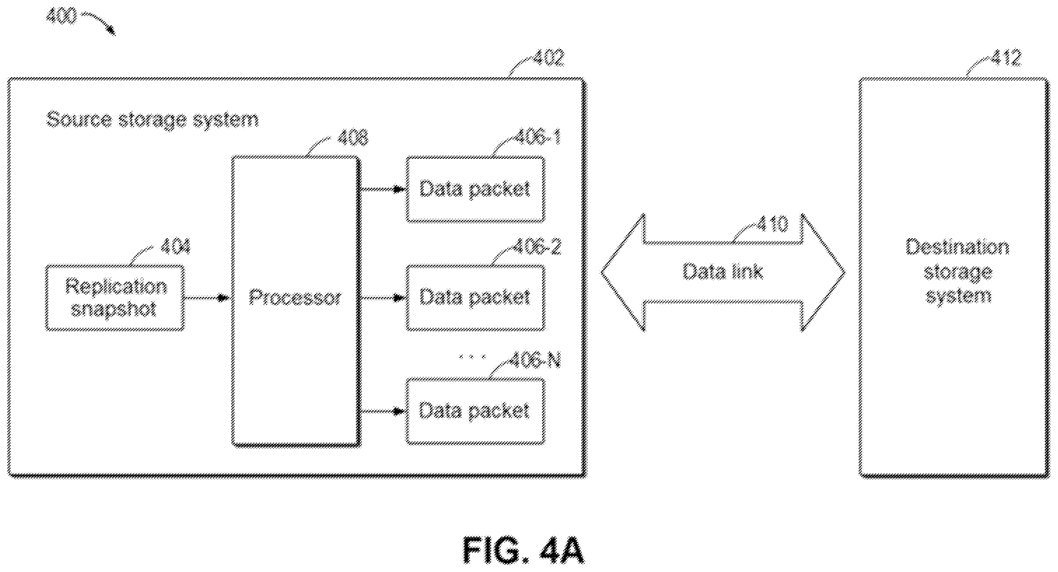

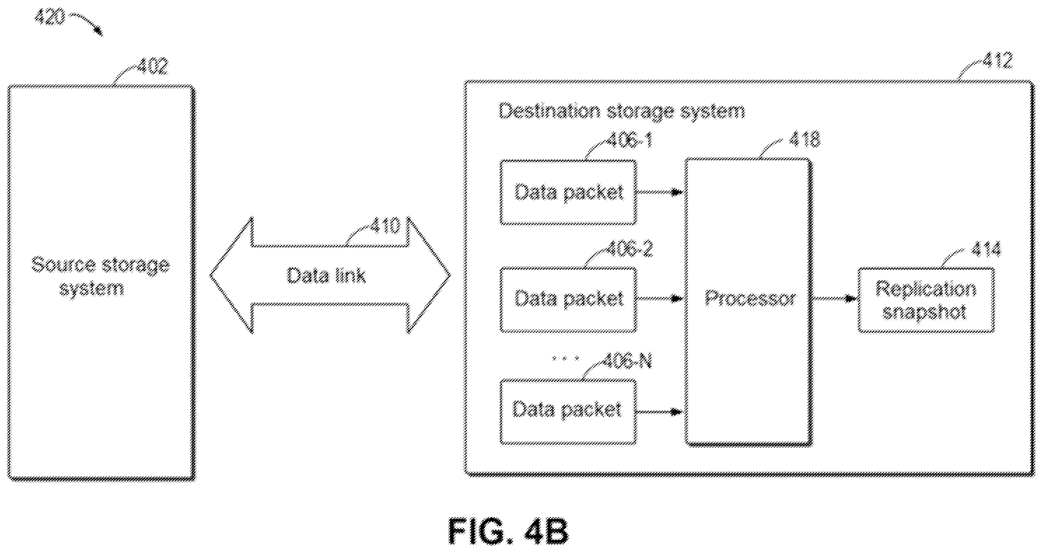

FIG. 4A to FIG. 4B show a schematic diagram of a process 400 of splitting a replication snapshot at a source storage system according to some embodiments of the present disclosure, and a schematic diagram of a process 420 of packaging multiple split data packets at a destination storage system according to some embodiments of the present disclosure. As shown in FIG. 4A, the source storage system 402 (for example, the source storage system 102 in FIG. 1) stores a replication snapshot 404. A processor 408 of the source storage system 402 can split the replication snapshot 404 into multiple data packets, i.e., data packets 406-1, 406-2, . . . , and 406-N (which are all referred to as a data packet 406). Then, a data link 410 is used to concurrently transmit multiple data packets 406 to a destination storage system 412. It should be noted that when the processor 408 is used to split the replication snapshot into multiple data packets 406, corresponding processor resources for splitting data packets need to be consumed, and the consumed processor resources depend on the number of times the data is split; the more times the split occurs, the more split data packets, and the higher the efficiency of concurrent transmission, the more the corresponding consumption of processor resources.

As shown in FIG. 4B, after the destination storage system 412 receives multiple data packets 406 from the source storage system 402 via the data link 410, the processor 418 of the destination storage system 412 can package the multiple data packets 406 so as to obtain a recovered replication snapshot 414, so as to complete a process of replicating the replication snapshot 404 from the source storage system 402 to the destination storage system 412. It should be noted that when the processor 418 is used to package multiple data packets 406, corresponding processor resources for packaging data packets need to be consumed, and the consumed processor resources depend on the number of split sub data packets after the replication snapshot 404 is split into sub data packets at the source storage system 402. The higher the number of split sub data packets is, the more times they need to be packaged, and correspondingly, the more processor resources are consumed.

In this way, the replication snapshot 404 can be split into multiple data packets 406 at the source storage system 402, and then the multiple data packets 406 are transmitted concurrently via the data link 410, so as to improve the bandwidth utilization rate of the data link 410, accelerate the speed of replicating the replication snapshot 404 from the source storage system 402 to the destination storage system 412, reduce the transmission time length, and improve the possibility of completing the transmission of replication incremental data within the RPO time.

The higher the number of split data packets, the higher the efficiency of the concurrent transmission, and the higher the speed of the transmission. However, as stated above, the more splitting times, the more processor resources need to be consumed for the splitting operation and the packaging operation. When the number of split data packets is too large, it will make the processor resources a bottleneck and even have a negative impact on the processor's execution of other tasks. Therefore, in order to complete the transmission of replication incremental data within the RPO time and limit the consumed processor resources to an acceptable range, it is necessary to determine the optimal split number for concurrent transmission of the replication incremental data.

In some embodiments, before determining an optimal split number, it can be determined whether to concurrently transmit the target data packet (for example, the target replication snapshot). In some embodiments, an average transmission speed of the data link can be determined, and the ratio of the average transmission speed to a theoretical bandwidth of the data link can be determined. Then, the ratio can be compared with a predetermined threshold, and the target data packet is directly transmitted without splitting in response to determining that the ratio is greater than or equal to the predetermined threshold.

In some embodiments, before determining the optimal split number, the average transmission speed of the data link can be determined, and a data size of the target data packet can be determined. Then, the transmission time length for transmitting the target data packet can be determined in a case where the target data packet is not split based on the average transmission speed and the data size of the target data packet. In response to determining that the transmission time length is less than or equal to the target time period, the target data packet is directly transmitted without splitting.

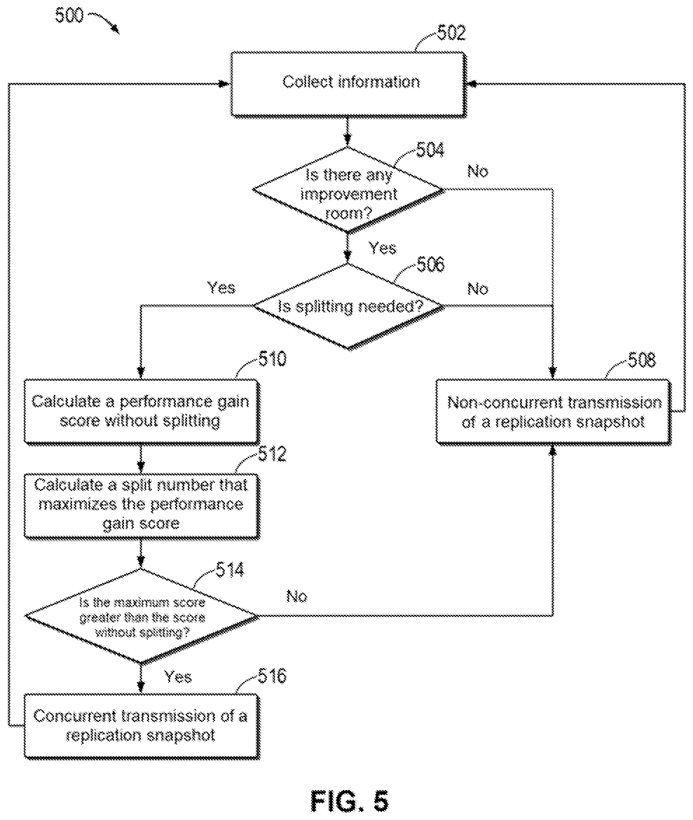

FIG. 5 shows a flowchart of a process 500 of determining whether to concurrently transmit a replication snapshot and determining a split number according to some embodiments of the present disclosure. As shown in FIG. 5, in a block 502, information is collected in the process 500. For example, the collected information may include a real average transmission speed and a theoretical bandwidth of a data link (for example, the data link 120 in FIG. 1), and may further include an RPO value of a replication session and time required for transmitting the target replication snapshot (for example, the replication snapshot 216 in FIG. 2). In some embodiments, the processor utilization rate for transmitting a historical replication snapshot within certain RPO time in the past and the average transmission speed and the bandwidth utilization rate of the data link can be determined. In some embodiments, the processor utilization rate can be determined by determining a mean value of multiple processor utilization rates of transmitting multiple historical replication snapshots within multiple previous RPO time, and the average transmission speed and the bandwidth utilization rate of the data link can be determined by determining a mean value of multiple bandwidth utilization rates for transmitting multiple historical replication snapshots.

At a block 504, in the process 500, it can be determined based on the average transmission speed and the theoretical bandwidth of the data link whether there is still room for improvement in the transmission speed of the data link. If the bandwidth of the data link has been fully utilized, even splitting the replication snapshot for concurrent transmission cannot further improve the transmission speed. In some embodiments, a ratio of the average transmission speed of the data link to the theoretical bandwidth can be determined. If the ratio is greater than or equal to a predetermined threshold, it indicates that the bandwidth of the data link has been fully utilized and has no improvement room. Then, the process 500 proceeds to a block 508. At the block 508, a replication snapshot is directly transmitted from a source storage system to a destination storage system during the process 500 without splitting.

Return to the block 504. If the ratio of the average transmission speed of the data link to the theoretical bandwidth is less than the predetermined threshold, it indicates that the transmission speed still has room to be improved. The process 500 proceeds to a block 506. At the block 506, it is determined in the process 500 whether the target replication snapshot needs to be split based on the RPO time and the transmission time length required to transmit the target replication snapshot. In some embodiments, the transmission time length for transmitting a replication snapshot can be determined based on the average transmission speed of the data link and a total data size of the replication snapshot to be transmitted. If the transmission time length is less than or equal to the RPO time, it indicates that the replication snapshot can be transmitted within the RPO time, and then the process 500 proceeds to the block 508. If the transmission time length is greater than the RPO time, it indicates that the transmission of the replication snapshot cannot be completed within the RPO time, and it is necessary to split the replication snapshot to concurrently transmit multiple split data packets so as to improve the transmission speed and enable the replication snapshot to complete transmission within the RPO time.

At a block 510, a performance gain score of not splitting the replication snapshot is calculated during the process 500. The performance gain score indicates an overall performance of a system under the current splitting method (such as not splitting, splitting into two data packets, splitting into three data packets, etc.). A higher performance gain score indicates that the overall performance of the system is better or more in line with user requirements. In some embodiments, the performance gain score can be determined by comprehensively considering the processor consumption, transmission time consumption, and bandwidth utilization rate under the current splitting method. In some embodiments, a processor consumption score, a transmission time consumption score, and a bandwidth utilization score for transmitting the target data packet in a specific splitting method can be determined based on a processor utilization rate related to the transmission of the historical replication snapshot and a bandwidth utilization rate of the data link, the time consumption related to the transmission of the target replication snapshot, the split processor resource related to the splitting operation, and the packaging processor resource related to the packaging operation. Then, the performance gain score can be determined based on the processor consumption score, the transmission time consumption score, and the bandwidth utilization score.

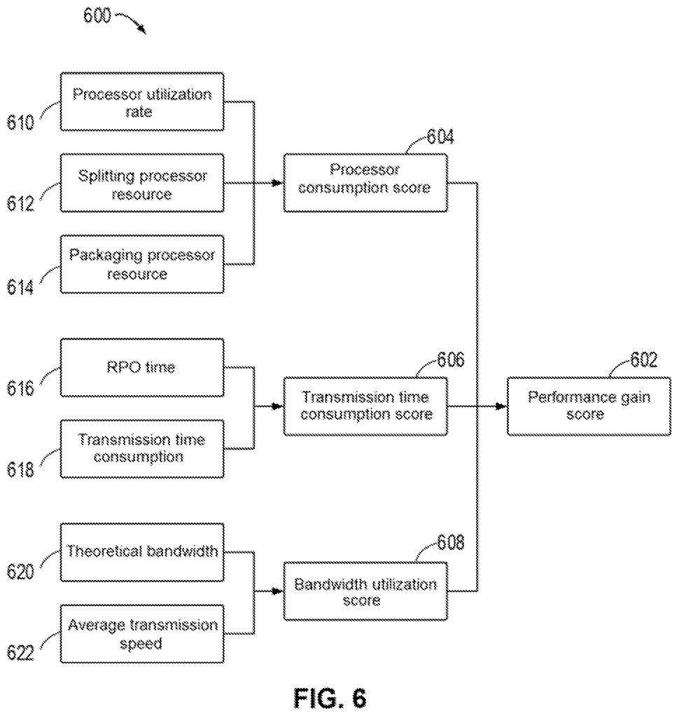

The composition of a performance gain score according to some embodiments of the present disclosure is described below with reference to FIG. 6. FIG. 6 shows a schematic diagram of a process 600 of determining a performance gain score according to some embodiments of the present disclosure. As shown in FIG. 6, a performance gain score 602 includes a processor consumption score 604, a transmission time consumption score 606, and a bandwidth consumption score 608. The processor consumption score 604 can be calculated based on a processor utilization rate 610, a splitting processor resource 612, and a packaging processor resource 614. In some embodiments, the processor utilization rate 610 can be calculated by counting a processor utilization rate of a source storage system and a processor utilization rate of a target storage system when a historical replication snapshot is transmitted. In some embodiments, the transmission time consumption score 606 can be calculated based on the RPO time 616 (i.e., a RPO value of a replication session) and the time consumption 618 of transmitting the replication snapshot from the source storage system to the destination storage system, where measurement units for the RPO time 616 and the transmission time consumption 618 can be seconds. For example, the RPO time 616 can be 600 seconds, and the transmission time consumption 618 can be 240 seconds. In some embodiments, an average transmission speed 622 of a data link can be calculated during the transmission of the historical replication snapshot, and a bandwidth utilization score 608 is calculated based on the average transmission speed 622 and a theoretical bandwidth 620 of the data link, where measurement units of the theoretical bandwidth 620 and the average transmission speed 622 can be Megabits per second (Mbps).

In some embodiments, different weights can be assigned to the processor consumption score 604, the transmission time consumption score 606, and the bandwidth utilization score 608 based on user requirements, and then the performance gain score 602 is determined by weighting these scores. For example, if the processor configuration of the storage system is low, users may be sensitive to processor consumption, which can increase the weight of the processor consumption score 604, making changes in processor resource consumption more significantly affect the performance gain score 602. On the contrary, if the processor configuration of the storage system is high, users may not be sensitive to processor resource consumption and hope that the source storage system can split the replication snapshot into more data packets to improve the speed of concurrent transmission, thereby reducing the weight of the processor consumption score 604. In some embodiments, the sum of the weight of the processor consumption score 604, the weight of the transmission time consumption score 606, and the weight of the bandwidth utilization score 608 is 1.

Return to FIG. 5. At the block 512, multiple candidate split numbers can be determined, and a candidate split number to maximize the performance gain score can be calculated in the process 500. For example, in the process 500, multiple performance gain scores for transmitting the target replication snapshot based on different candidate split numbers can be calculated, and then the candidate split number to maximize the performance gain scores can be determined by comparing multiple performance gain scores. At the block 514, in the process 500, it is determined whether the maximum performance gain score is greater than the performance gain score without splitting. If the performance gain score without splitting is greater than or equal to the maximum performance gain score, the process 500 proceeds to the block 508. If the maximum performance gain score is greater than the performance gain score without splitting, the candidate split number is determined as a target split number in the process 500, and the process 500 proceeds to the block 516.

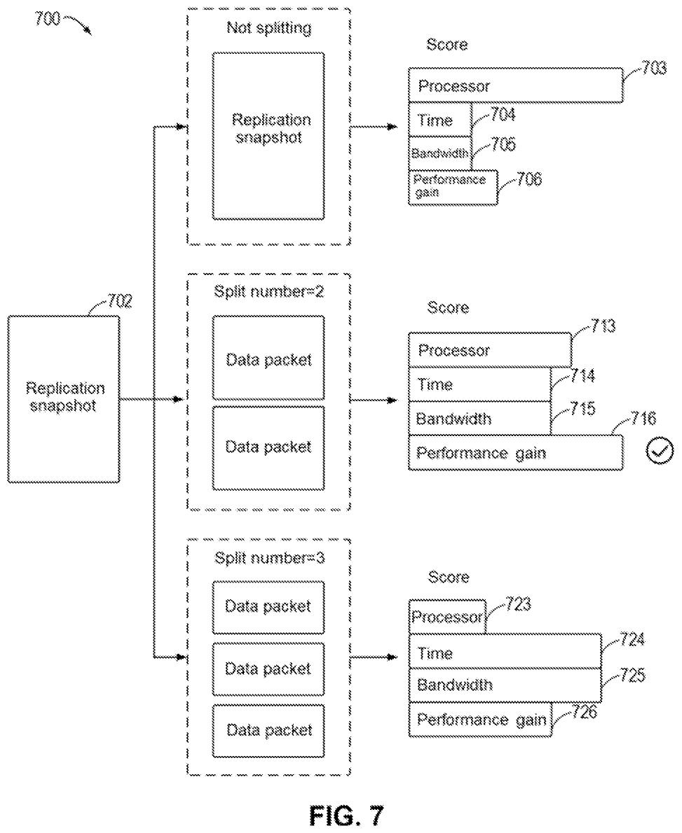

A process of determining an optimal split number according to some embodiments of the present disclosure is described below with reference to FIG. 7. FIG. 7 shows a schematic diagram of an example 700 of determining an optimal split number according to some embodiments of the present disclosure. As shown in FIG. 7, a replication snapshot 702 is a target replication snapshot to be transmitted from a source storage system to a destination storage system. If the replication snapshot 702 is not split, scores related to transmission of the replication snapshot 702 include a processor consumption score 703, a transmission time consumption score 704, and a bandwidth utilization score 705. In the example 700, since the replication snapshot 702 is not split, there is no need to consume split processor resources and package processor resources. Therefore, the processor consumption score 703 is relatively high, while the transmission time consumption score 704 and the bandwidth utilization score 705 are relatively low. After weighted summation is performed on the processor consumption score 703, the transmission time consumption score 704, and the bandwidth utilization score 705, a performance gain score 706 is obtained.

In the example 700, if the replication snapshot 702 is split into two data packets (i.e., the split number is 2) for concurrent transmission, scores related to the transmission of the replication snapshot 702 include a processor consumption score 713, a transmission time consumption score 714, and a bandwidth utilization score 715. As shown in FIG. 7, since concurrent transmission is used, the transmission time consumption score 714 is higher than the transmission time consumption score 704 without splitting, and the bandwidth utilization score 715 is higher than the bandwidth utilization score 705 without splitting. However, due to the split processor resources and packaging processor resources being consumed for splitting the replication snapshot 702, the processor consumption score 713 is lower than the processor consumption score 703 without splitting. After weighted summation is performed on the processor consumption score 713, the transmission time consumption score 714, and the bandwidth utilization score 715, a performance gain score 716 is obtained; in the example 700, the performance gain score 716 is higher than the performance gain score 706 without splitting.

In the example 700, if the replication snapshot 702 is split into three data packets (i.e., the split number is 3) for concurrent transmission, scores related to transmission of the replication snapshot 702 includes a processor consumption score 723, a transmission time consumption score 724, and a bandwidth utilization score 725. As shown in FIG. 7, since the replication snapshot 702 is split into more data packets for concurrent transmission, the transmission time consumption score 724 is higher than the transmission time consumption score 704 without splitting and the transmission time consumption score 714 when the split number is 2, and the bandwidth utilization score 725 is higher than the bandwidth utilization score 705 without splitting and the bandwidth utilization score 705 when the split number is 2. However, due to the need to perform more times of data packet splitting and packaging operations, the processor consumption score 723 is lower than the processor consumption score 703 without splitting and the processor consumption score 713 when the split number is 2. After weighted summation is performed on the processor consumption score 723, the transmission time consumption score 724, and the bandwidth utilization score 725, a performance gain score 726 is obtained. In the example 700, the performance gain score 726 is higher than the performance gain score 706 without splitting but lower than the performance gain score 716 when the split number is 2. In the candidate split numbers shown in FIG. 7, when the split number is 2, the performance gain score can be maximum, and the performance gain score 716 is greater than the performance gain score 706 without splitting; therefore, it can be determined that the target split number is 2.

Return to FIG. 5. At the block 516, in the process 500, the target replication snapshot is split into multiple data packets, and the number of the multiple data packets is the target split number. Then, these data packets are concurrently transmitted from the source storage system to the destination storage system, and these data packets are packaged in the destination storage system to obtain a recovered replication snapshot. In some embodiments, the process 500 can return to the block 502 from the block 508 or the block 516 to recollect information so as to redetermine an optimal split number according to updated data.

In this way, the split number that maximizes the performance gain score can be calculated based on the degree to which users value various factors (a processor factor, a time factor, and a bandwidth factor). Therefore, it is possible to improve the bandwidth utilization rate and reduce the transmission time length while ensuring that the processor resource consumption is within an acceptable range for users. Thus, it can avoid splitting the target replication snapshot into too many data packets due to only considering reducing the transmission time length that results in processor resources becoming bottlenecks and reduces the overall performance of the system.

In some embodiments, several formulas introduced in the following text can be used to implement the process 500 shown in FIG. 5. In this text, As is used to represent a source storage system (for example, the source storage system 102 in FIG. 1), and Ad is used to represent a destination storage system (for example, the destination storage system 112 in FIG. 1). The source storage system includes a storage object oᵢ (for example, the storage object 104 in FIG. 1) with an asynchronous replication session, and/represents the number of the storage objects. In addition, Rᵢ is used to represent a replication snapshot corresponding to the storage object oᵢ, and Dᵢ is used to represent a data size of the replication snapshot Rᵢ; a total data size of all the replication snapshots Dₜ is calculated by the following equation (1):

$${D}_{t} = {\sum }_{i = 1}^{i = I} {D}_{i} \qquad ( 1 )$$

In this text, f_{B_r} is used to represent an average transmission speed of the data link, f_{B_r} is used to represent a theoretical bandwidth of the data link. Due to some factors in the network (such as signal interference, bandwidth sharing, transmission delay, etc.), the actual bandwidth of the data link cannot reach the theoretical bandwidth. Therefore, a threshold ratio w can be set. When f_{B_r}≥w*f_{B_t}, it indicates that the data link is fully utilized and does not have improvement room. When f_{B_r}<w*f_{B_1}, it indicates that the current the data transmission does not reach the theoretical bandwidth of the data link, the data link still has room for utilization.

In this text, T_{RPO} is used to represent a RPO value of a replication session, and time consumption T_{d} of transmitting all the replication snapshot Dₜ from the source storage system to the destination storage system by the following equation (2):

$${T}_{d} = \frac{{D}_{t}}{{f}_{B \_ r}} \qquad ( 2 )$$

If T_{d}>T_{RPO}, it indicates that the transmission of the replication snapshot cannot be completed within the RPO time, and the transmission speed of the replication snapshot needs to be improved. Therefore, in a case where f_{B_r}<w*f_{B_t} and T_{d}>T_{RPO}, the replication snapshot can be split into multiple data packets, and these data packets can be concurrently transmitted to improve the transmission speed and reduce the transmission time length.

A method for calculating the performance gain score of transmitting a replication snapshot from the source storage system to the destination storage system without splitting it according to some embodiments is introduced below. Suppose the processor utilization rate of the source storage system is Cₛ, and the processor utilization rate of the destination storage system is C_{d}, the overall processor utilization rate C_{wo} of the system is calculated by the following equation (3), and there is no measurement unit for the processor utilization rate C_{wo}:

$${C}_{wo} = {C}_{s} + {C}_{d} \qquad ( 3 )$$

Since the lower C_{wo}, the higher the processor consumption score, the reciprocal of C_{wo} can be used to represent the processor consumption score. In addition, the time consumption T_{wo} of transmitting the replication snapshot from the source storage system to the destination storage system can be calculated by the following equation (4):

$${T}_{wo} = \frac{{D}_{t}}{{f}_{B \_ r}} = {\sum }_{i = 1}^{i = I} {D}_{i} / {f}_{B \_ r} \qquad ( 4 )$$

Since the measurement unit of the time consumption T_{wo} is time (for example, seconds), it needs to be standardized. For example, T_{wo} can be compared with T_{RPO} through the following equation (5) so as to obtain a time consumption score RT_{wo}:

$${RT}_{wo} = \frac{{T}_{RPO}}{{T}_{wo}} = \frac{{T}_{RPO}}{{\sum }_{i = 1}^{i = I} {D}_{i} / {f}_{B \_ r}} = \frac{{T}_{RPO} * {f}_{B \_ r}}{{\sum }_{i = 1}^{i = I} {D}_{i}} \qquad ( 5 )$$

In addition, the bandwidth utilization rate B_{wo} (i.e., the bandwidth utilization score) of the data link is calculated through the following equation (6):

$${B}_{wo} = \frac{{f}_{B \_ r}}{{f}_{B \_ t}} \qquad ( 6 )$$

In some embodiments, according to the user's requirements, a weight we can be allocated to the processor consumption score, a weight w_{T} can be allocated to the time consumption score, and a weight w_{B} can be allocated to the bandwidth utilization score, where 7>w_{C}+w_{T}+w_{B}=1, so as to calculate a performance gain score S_{wo} without splitting through the following equation (7).

$${s}_{wo} = {w}_{c} * \frac{1}{{C}_{wo}} + {w}_{T} * {RT}_{wo} + {w}_{B} * {B}_{wo} \qquad ( 7 )$$

A method for calculating a performance gain score of concurrently transmitting multiple data packets to a destination storage system in a case where a replication snapshot is split into multiple data packets according to some embodiments is introduced below. In this text, Ne is used to represent a maximum split number that the replication snapshot can be split into, and Ne can be calculated through the following equation (8):

$${N}_{c} = int ( \frac{{f}_{B \_ t}}{{f}_{B \_ r}} ) , \qquad ( 8 )$$

where int indicates a rounding function.

If N_{c}=1, it indicates that the bandwidth of the data link is fully utilized; at this time, the replication snapshot is not split. If N_{c}>1, it indicates that the bandwidth of the data link still has room for utilization; correspondingly, the data transmission speed also has room for improvement. Suppose the replication snapshot is split into Nₖ data packets, Cᵤ is used to represent processor resource consumption of performing one splitting operation by the source storage system, Cₚ is used to represent processor resource consumption of performing one packaging operation by the destination storage system, and the overall processor utilization rate C_{w} of the system can be calculated through the following equation (9):

$${C}_{w} = {C}_{s} + {C}_{d} + {C}_{u} * ( {N}_{k} - 1 ) + {C}_{p} * ( {N}_{k} - 1 ) \qquad ( 9 )$$

Since the lower C_{w}, the higher the processor consumption score, a reciprocal of C_{w} can be used to represent the processor consumption score. In addition, since the replication snapshot is split into Nₖ data packets for concurrent transmission, the data transmission speed can be improved to f_{B_r}*Nₖ, where f_{B_r}*Nₖ/f_{B_t} and 1≤Nₖ≤N_{c}. Then, the time consumption T_{w} of transmitting all the replication snapshots Dt from the source storage system to the destination storage system can be calculated through the following equation (10):

$${T}_{w} = \frac{{D}_{t}}{{f}_{B \_ r} * {N}_{k}} = \frac{{\sum }_{i = 1}^{i = I} {D}_{i}}{{f}_{B \_ r} * {N}_{k}} \qquad ( 10 )$$

Then, T_{w} can be compared with T_{RPO} through the following equation (11) so as to obtain a time consumption score R_{Tw}:

$${RT}_{w} = \frac{{T}_{RPO}}{{T}_{w}} = \frac{{T}_{RPO} * {f}_{B \_ r} * {N}_{k}}{{\sum }_{i = 1}^{i = I} {D}_{i}} \qquad ( 11 )$$

In addition, a bandwidth utilization score B_{w} can be calculated through the following equation (12):

$${B}_{w} = \frac{{f}_{B \_ r} * {N}_{k}}{{f}_{B \_ t}} \qquad ( 12 )$$

A performance gain score S_{w} of splitting the replication snapshot into Nₖ data packets for concurrent transmission can be calculated through the following equation (13) in combination with the above equations (9), (11), and (12):

$$\begin{matrix}{s}_{w} = {w}_{c} * \frac{1}{{C}_{w}} + {w}_{T} * {RT}_{w} + {w}_{B} * {B}_{w} \\ = {w}_{c} * \frac{1}{{C}_{s} + {C}_{d} + {C}_{u} * ( {N}_{k} - 1 ) + {C}_{p} * ( {N}_{k} - 1 )} + \\ {w}_{T} * \frac{{T}_{RPO} * {f}_{B \_ r} * {N}_{k}}{{\sum }_{i = 1}^{i = I} {D}_{i}} + {w}_{B} * \frac{{f}_{B \_ r} * {N}_{k}}{{f}_{B \_ t}} \\ = \frac{{w}_{c}}{{N}_{k} * ( {C}_{u} + {C}_{p} ) + {C}_{s} + {C}_{d} - {C}_{u} - {C}_{p}} + \\ \frac{{w}_{T} * {T}_{RPO} * {f}_{B \_ r} * {N}_{k}}{{\sum }_{i = 1}^{i = I} {D}_{i}} + \frac{{w}_{B} * {f}_{B \_ r} * {N}_{k}}{{f}_{B \_ t}}\end{matrix} \qquad ( 13 )$$

The greater the performance gain score S_{w}, the better the performance of the data transmission. Since the performance gain score S_{w} depends on the value of Nₖ, Nₖ that maximizes S_{w} can be calculated, and Nₖ must meet the conditions of the following equation (14):

$$\{ \begin{matrix}max ( {s}_{w} ) \\ s . t . 1 \leq {N}_{k} \leq int ( \frac{{f}_{B \_ t}}{{f}_{B \_ r}} )\end{matrix} \qquad ( 14 )$$

Then, a performance gain score S_{wo} when not splitting can be compared with a maximum performance gain score max max(S_{w}) when splitting; if S_{wo}≥max(S_{w}), the replication snapshot can be directly transmitted without splitting. If S_{wo}<max(S_{w}), the replication snapshot is split into Nₖ data packets for concurrent transmission so as to improve the performance of data transmission.

In this way, it is possible to quantify the performance gain of splitting a replication snapshot into different numbers of data packets for concurrent transmission. Therefore, an optimal split number can be found by comparing performance gain scores corresponding to different split numbers, improving the performance of the process of transmitting the replication snapshot from a source storage system to a destination storage system. Therefore, it avoids splitting the target replication snapshot into too many data packets due to only considering reducing the transmission time length that results in processor resources becoming bottlenecks and reduces the overall performance of the system.

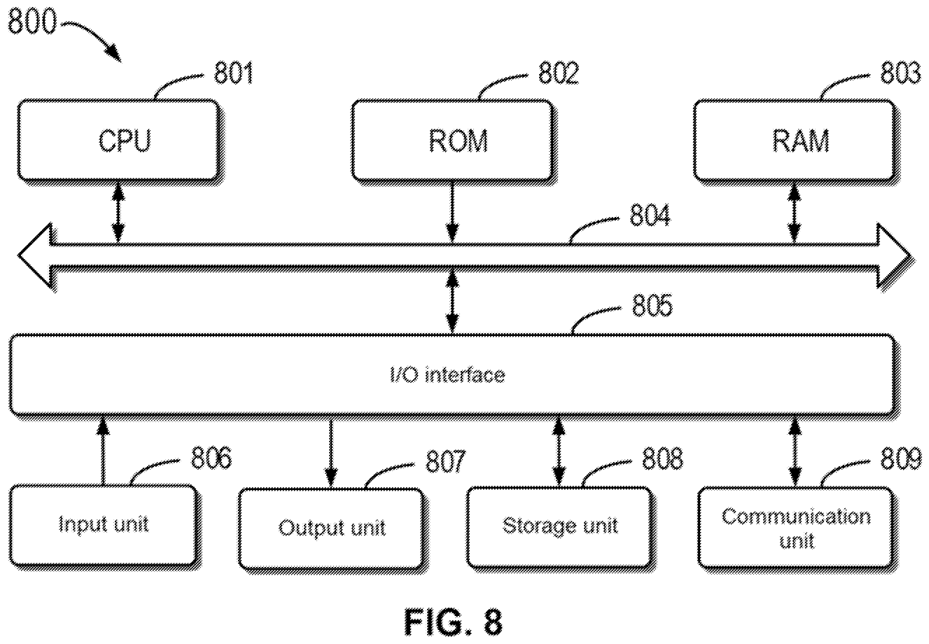

FIG. 8 shows a schematic block diagram of an example device 800 that may be used to implement an embodiment of the present disclosure. As shown in the figure, a device 800 includes a computing unit 801, which may execute various appropriate actions and processing according to computer program instructions stored in a read-only memory (ROM) 802 or computer program instructions loaded from a storage unit 808 onto a random access memory (RAM) 803. Various programs and data required for the operation of the device 800 may also be stored in the RAM 803. The computing unit 801, the ROM 802, and the RAM 803 are connected to each other through a bus 804. An input/Output (I/O) interface 805 is also connected to the bus 804.

A plurality of components in the device 800 are connected to the I/O interface 805, including: an input unit 806, such as a keyboard and a mouse; an output unit 807, such as various types of displays and speakers; a storage unit 808, such as a magnetic disk and an optical disc; and a communication unit 809, such as a network card, a modem, and a wireless communication transceiver. The communication unit 809 allows the device 800 to exchange information/data with other devices via a computer network, such as the Internet, and/or various telecommunication networks.

The computing unit 801 may be various general-purpose and/or special-purpose processing components with processing and computing capabilities. Some examples of the computing unit 801 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 801 performs various methods and processes described above, such as the method 300. For example, in some embodiments, the method 300 may be implemented as a computer software program that is tangibly included in a machine-readable medium such as the storage unit 808. In some embodiments, part or all of the computer program may be loaded and/or installed onto the device 800 via the ROM 802 and/or the communication unit 809. When the computer program is loaded to the RAM 803 and executed by the computing unit 801, one or more steps of the method 300 described above may be performed. Alternatively, in other embodiments, the computing unit 801 may be configured to implement the method 300 in any other suitable manners (such as by means of firmware).

The functions described herein above may be performed, at least in part, by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program code for implementing the method of the present disclosure may be written by using one programming language or any combination of a plurality of programming languages. The program code may be provided to a processor or controller of a general purpose computer, a special purpose computer, or another programmable data processing apparatus, such that the program code, when executed by the processor or controller, implements the functions/operations specified in the flowcharts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include a one or more wires-based electrical connection, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combinations thereof. Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

What is claimed is:

1. A method, comprising:
acquiring, by a system comprising a processor, a processor utilization rate related to transmission of one or more historical data packets and a bandwidth utilization rate of a data link within a target time period;
determining a time consumption for transmission of a target data packet, a first processing resource related to a splitting operation, and a second processing resource related to a packaging operation; and
determining, based on the processor utilization rate, the bandwidth utilization rate, the time consumption, the first processing resource, and the second processing resource, a split number for the target data packet to concurrently transmit the target data packet.

2. The method according to claim 1, wherein the split number is a target split number, and determining the target split number comprises:
determining a first candidate split number and a second candidate split number;
determining, based on the processor utilization rate, the bandwidth utilization rate, the time consumption, the first processing resource, and the second processing resource, a first performance gain score of transmitting the target data packet based on the first candidate split number and a second performance gain score of transmitting the target data packet based on the second candidate split number; and
in response to the first performance gain score being determined to be greater than the second performance gain score and the first candidate split number being determined to be less than or equal to a theoretical maximum split number, determining the first candidate split number as the target split number.

3. The method according to claim 2, wherein determining the first performance gain score of transmitting the target data packet based on the first candidate split number comprises:
determining, based on the processor utilization rate, the bandwidth utilization rate, the time consumption, the first processing resource, and the second processing resource, a processor consumption score, a transmission time consumption score, and a bandwidth utilization score of transmitting the target data packet based on the first candidate split number; and
determining the first performance gain score based on the processor consumption score, the transmission time consumption score, and the bandwidth utilization score.

4. The method according to claim 3, wherein determining the processor consumption score comprises:
determining the processor consumption score based on the processor utilization rate, the second processing resource, the first processing resource, and the first candidate split number.

5. The method according to claim 3, wherein determining the transmission time consumption score comprises:
determining the transmission time consumption score based on an average transmission speed of the data link, a size of the target data packet, the first candidate split number, and the target time period.

6. The method according to claim 3, wherein determining the bandwidth utilization score comprises:
determining the bandwidth utilization score based on the average transmission speed of the data link, a theoretical bandwidth of the data link, and the first candidate split number.

7. The method according to claim 3, wherein determining the first performance gain score further comprises:
determining a first weight for the processor consumption score, a second weight for the transmission time consumption score, and a third weight for the bandwidth utilization score; and
determining the first performance gain score based on the processor consumption score, the first weight, the transmission time consumption score, the second weight, the bandwidth utilization score, and the third weight.

8. The method according to claim 1, further comprising:
determining an average transmission speed of the data link;
determining a ratio of the average transmission speed to a theoretical bandwidth of the data link;
comparing the ratio with a specified threshold; and
in response to determining that the ratio is greater than or equal to the specified threshold, directly transmitting the target data packet without splitting.

9. The method according to claim 1, further comprising:
determining an average transmission speed of the data link;
determining a data size of the target data packet;
determining, based on the average transmission speed and the data size, a transmission time length for transmission of the target data packet without splitting the target data packet;
comparing the transmission time length with the target time period; and
in response to determining that the transmission time length is less than or equal to the target time period, directly transmitting the target data packet without splitting.

10. The method according to claim 1, wherein determining the processor utilization rate, the time consumption, and the bandwidth utilization rate comprises:
determining the processor utilization rate by determining a mean value of multiple processor utilization rates used for transmission of multiple historical data packets within multiple earlier target time periods; and
determining the bandwidth utilization rate by determining a mean value of multiple bandwidth utilization rates used for transmission of the multiple historical data packets.

11. The method according to claim 1, wherein the target time period is a recovery point objective, the one or more historical data packets are one or more historical replication snapshots, and the target data packet is a target replication snapshot.

12. A device, comprising:
at least one processor; and
a memory coupled to the at least one processor and having instructions stored thereon, wherein the instructions, when executed by the at least one processor, cause the device to perform actions comprising:
acquiring a processor utilization rate related to transmission of a historical data packet and a bandwidth utilization rate of a data link within a target time period;
determining time consumption for transmission of a target data packet, a first processing resource related to a splitting operation, and a second processing resource related to a packaging operation; and
determining, based on the processor utilization rate, the bandwidth utilization rate, the time consumption, the first processing resource, and the second processing resource, a split number for the target data packet applicable to a concurrent transmission of the target data packet.

13. The device according to claim 12, wherein the split number is a target split number, and determining the target split number comprises:
determining a first candidate split number and a second candidate split number;
determining, based on the processor utilization rate, the bandwidth utilization rate, the time consumption, the first processing resource, and the second processing resource, a first performance gain score of transmitting the target data packet based on the first candidate split number and a second performance gain score of transmitting the target data packet based on the second candidate split number; and
in response to determining that the first performance gain score is greater than the second performance gain score and the first candidate split number is less than or equal to a theoretical maximum split number, determining the first candidate split number as the target split number.

14. The device according to claim 13, wherein determining a first performance gain score of transmitting the target data packet based on the first candidate split number comprises:
determining, based on the processor utilization rate, the bandwidth utilization rate, the time consumption, the first processing resource, and the second processing resource, a processor consumption score, a transmission time consumption score, and a bandwidth utilization score of transmitting the target data packet based on the first candidate split number; and
determining the first performance gain score based on the processor consumption score, the transmission time consumption score, and the bandwidth utilization score.

15. The device according to claim 14, wherein determining the processor consumption score comprises:
determining the processor consumption score based on the processor utilization rate, the second processing resource, the first processing resource, and the first candidate split number.

16. The device according to claim 14, wherein determining the transmission time consumption score comprises:
determining the transmission time consumption score based on an average transmission speed of the data link, a size of the target data packet, the first candidate split number, and the target time period.

17. The device according to claim 14, wherein determining the bandwidth utilization score comprises:
determining the bandwidth utilization score based on the average transmission speed of the data link, a theoretical bandwidth of the data link, and the first candidate split number.

18. The device according to claim 14, wherein determining the first performance gain score further comprises:
determining a first weight for the processor consumption score, a second weight for the transmission time consumption score, and a third weight for the bandwidth utilization score; and
determining the first performance gain score based on the processor consumption score, the first weight, the transmission time consumption score, the second weight, the bandwidth utilization score, and the third weight.

19. A computer program product, the computer program product being stored on a non-transitory computer-readable medium and comprising machine-executable instructions, wherein the machine-executable instructions, when executed, cause a machine to perform operations comprising:
acquiring a processor utilization rate related to transmission of at least one historical data packet and a bandwidth utilization rate of a data link within a target time period;
determining a time consumption for transmission of a target data packet, a first processing resource related to a splitting operation, and a second processing resource related to a packaging operation; and
determining, based on the processor utilization rate, the bandwidth utilization rate, the time consumption, the first processing resource, and the second processing resource, a split number for the target data packet to use for a concurrent transmission of the target data packet.

20. The device according to claim 19, the operations further comprising:
determining an average transmission speed of the data link;
determining a ratio of the average transmission speed to a theoretical bandwidth of the data link;
comparing the ratio with a predetermined threshold; and
in response to determining, based on the comparing, that the ratio is greater than or equal to the predetermined threshold, directly transmitting the target data packet without splitting.
